(19) United States
(12) Patent Application Publication
(10) Pub. No.: US 2007/0120048 A1
(43) Pub. Date: May 31, 2007

(54) Reflective encoder module

(76) Inventors: Chee Foo Lum, Penang (MY); Weng Fei Wong, Penang (MY); Siang Leong Foo, Penang (MY)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/287,178

(22) Filed: Nov. 25, 2005

(51) Int. Cl. G01D 5/34

(52) U.S. Cl. 250/231.13

(57) ABSTRACT

An encoder having a carrier that passes through an opening in a mounting body is disclosed. The carrier includes an encoding region having a plurality of clear and opaque regions, the carrier having first and second surfaces. The clear and opaque regions of the carrier pass through the opening in the mounting body when the carrier moves relative to the mounting body. A light emitter generates a light signal that passes through the carrier, the light emitter being located adjacent to the first side of the carrier and separated therefrom. A light reflector is attached to the mounting body at a position such that the light reflector directs the light signal through the second surface of the carrier where a photodetector measures light leaving the first surface of the carrier when one of the clear regions passes through the light signal.

### BACKGROUND OF THE INVENTION

Encoders provide a measurement of the position of a component in a system relative to some predetermined reference point. Encoders are typically used to provide a closed-loop feedback system to a motor or other actuator. For example, a shaft encoder outputs a digital signal that indicates the position of the rotating shaft relative to some known reference position that is not moving. A linear encoder measures the distance between the present position of a moveable carriage and a reference position that is fixed with respect to the moveable carriage as the moveable carriage moves along a predetermined path.

Optical encoders utilize a light source and a photodetector to measure changes in the relative position of the carrier that includes an encoding pattern. In a transmissive encoder, the carrier includes a pattern consisting of a series of alternating opaque and transparent bands. The light source is located on one side of the carrier on which this pattern is located, and the photodetector is located on the other side of the carrier. The light source and photodetector are fixed relative to one another, and the carrier moves between the light source and the photodetector such that the light reaching the photodetector is interrupted by the opaque regions of the pattern. The position of the carrier is determined by measuring the transitions between the light and dark regions observed by the photodetector.

In a reflective encoder, the light source and photodetector are located on the same side of the carrier, and the encoding pattern consists of alternating reflective and absorbing bands. The light source is positioned such that light from the light source is reflected onto the photodetector when the light is reflected from the reflective bands.

Transmissive encoders have a number of advantages over reflective encoders in terms of tolerance, cost of code strips, and contrast ratios. In a transmissive encoder, the light from the light source is collimated before it reaches the carrier, and hence, the light leaving the carrier is also collimated. The detection assembly needs only to image this collimated light onto the detector surface.

In a reflective encoder, the distance between the carrier and the detector is critical as either the pattern itself or the light source as seen in the reflected light from the reflective bands is imaged into the detector. Hence, if there is an error in the carrier to detector module distance, the image will be out of focus and errors will result. In addition, the bands for reflective encoders have a contrast ratio determined by the ratio of the reflectance of the reflective and absorptive regions. This ratio tends to be less than the ratio of the absorbance of the clear and opaque regions of a transmissive code strip.

Unfortunately, transmissive encoders require that the two separate components, the light source and photodetector, be mounted and aligned with one another at the time of assembly of the encoder. This increases the burden on the manufacturer of the final product that incorporates the encoder. Reflective encoders, in contrast, are constructed from a single emitter-receiver element that is packaged together with the various optical components for imaging the light source onto the photodetector. Hence, the manufacturer only has to mount and align one component. Ideally, the manufacturer would like to have a reflective encoder that has the relaxed tolerances associated with a transmissive encoder.

### SUMMARY OF THE INVENTION

The present invention includes an encoder having a carrier that passes through an opening in a mounting body. The carrier includes an encoding region having a plurality of clear and opaque regions, the carrier having first and second surfaces. The clear and opaque regions of the carrier pass through the opening in the mounting body when the carrier moves relative to the mounting body. A light emitter generates a light signal that passes through the carrier, the light emitter being located adjacent to the first side of the carrier and separated therefrom. A light reflector is attached to the mounting body at a position such that the light reflector directs the light signal through the second surface of the carrier. A photodetector measures light leaving the first surface of the carrier when one of the clear regions passes through the light signal as the carrier moves relative to the mounting body. The photodetector is located on the same side of the carrier as the light emitter. The light emitter and photodetector can be attached to the mounting body. The light reflector can include one or more mirrors positioned such that collimated light generated by the light emitter passes through the carrier at right angles.

### BRIEF DESCRIPTION OF THE DRAWINGS

FIG. 1 illustrates a transmissive encoder.

FIG. 2 illustrates one type of reflective encoder.

FIG. 3 illustrates another form of reflective encoder.

FIG. 4 is a top view of an encoder showing the carrier and the underlying emitter-detector module.

FIG. 5 is a cross-sectional view through line 5-5 shown in FIG. 4.

FIG. 6 illustrates an embodiment of an encoder according to the present invention in which the light emitter is placed as close to the photodetector as possible.

FIG. 7 is a top view of a carrier with the light emitter and photodetector positioned in a radial manner under the encoding bands.

FIGS. 8 and 9 are cross-sectional views of additional embodiments of an encoder according to the present invention.

FIG. 10 is a top view of a linear encoder according to one embodiment of the present invention.

FIG. 11 is a cross-sectional view through line 11A-11A shown in FIG. 10.

### DETAILED DESCRIPTION OF THE PREFERRED EMBODIMENTS OF THE INVENTION

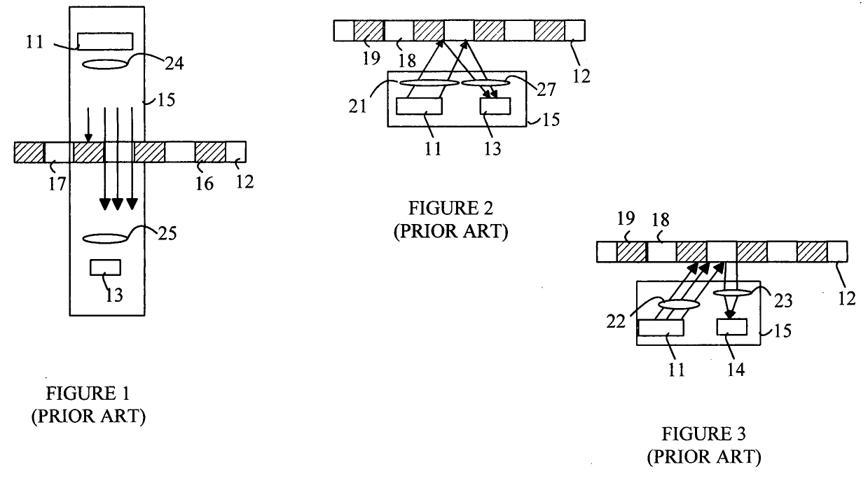

The manner in which the present invention provides its advantages can be more easily understood with reference to FIGS. 1-3, which illustrate some typical encoder designs. The encoder can be divided into an emitter/detector module 15 and a carrier that includes the encoding pattern. Module 15 includes an emitter 11 that illuminates a portion of the carrier 12. The illuminated pattern on the carrier is viewed by a detector 13. The emitter typically utilizes an LED as the light source. The detector is typically based on one or more photodiodes. FIG. 1 illustrates a transmissive encoder. In transmissive encoders, the light from the emitter is collimated into a parallel beam by a collimating optic such as lens 24. The carrier 12 includes opaque bands 16 and transparent bands 17. When carrier 12 moves between emitter 11 and detector 13, the light beam is interrupted by the opaque bands on the carrier. The photodiodes in the detector receive flashes of light. The resultant signal is then used to generate a logic signal that transitions between logical one and logical zero.

The detector can include an imaging lens 25 that images the collimated light onto the photodiode. Lens 25 can be used to adjust the size of the light bands to match the size of the photodiode or photodiodes in the detector. When used in this manner, the photodetector is placed at a point between the carrier and the focal point of lens 25. The distance between the photodetector and the lens determines the size of the code pattern image on the photodetector.

In general, the collimator is constructed from two separate sub-modules that are provided to the manufacturer of the completed encoder. The first sub-module includes the light source consisting of emitter 11 and lens 24. The second sub-module consists of photodetector 13 and lens 25. Since the light is collimated, the only critical distances are those between emitter 11 and lens 24 and between lens 25 and photodetector 13. These distances can be controlled to a high level of precision by the sub-module manufacturer. Hence, the tolerances that need to be maintained by the encoder manufacturer are substantially reduced in transmissive designs.

FIG. 2 illustrates one type of reflective encoder. In reflective encoders, the carrier includes reflective bands 18 and absorptive bands 19. The emitter includes an optical system such as a lens 21 that images the emitter light source into the detector when the light strikes a reflective band on the carrier. The light from the emitter is reflected or absorbed by the bands on the carrier. The output from the photodetector is again converted to a logic signal. In embodiments in which the photodetector includes a plurality of photodiodes that provide a signal that depends on matching an image of the bands to the photodiodes, a second lens 27 can be included to adjust the size of the pattern image to the size of the photodetectors in a manner analogous to that described above.

FIG. 3 illustrates another form of a reflective encoder that will be referred to as an imaging encoder in the following discussion. An imaging encoder operates essentially the same as the reflective encoder described above, except that module 15 includes imaging optic 23 that forms an image of the illuminated pattern on the carrier onto the detector 14. In addition, the light source is processed by lens 22 such that the pattern is uniformly illuminated in the region imaged onto the detector.

The present invention combines the benefits of the single module feature of a reflective encoder with the advantages of a transmissive encoder. The present invention can be used to construct both rotational encoders in which the carrier is a code disk and linear encoders in which the carrier is a code strip. To simplify the following discussion, the present invention will first be explained in terms of rotational encoders. The manner in which the present invention is used to construct a linear encoder will then be discussed in more detail.

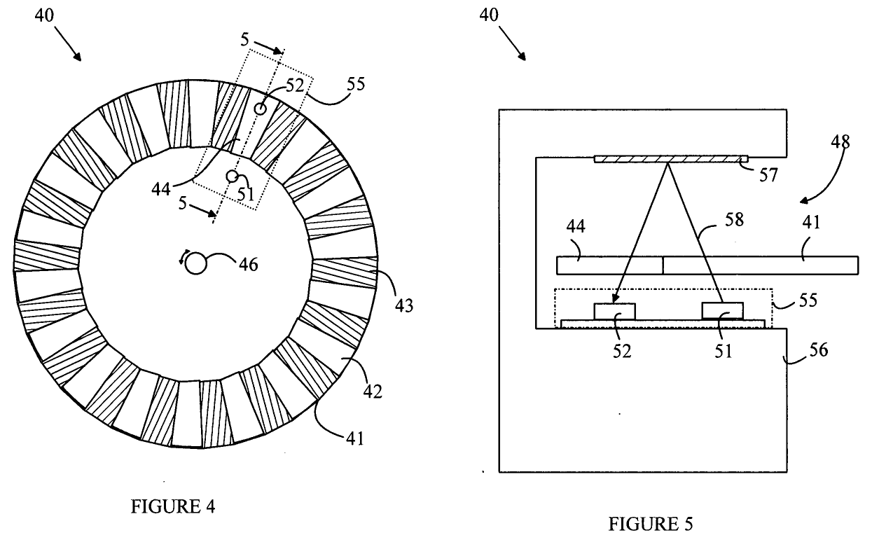

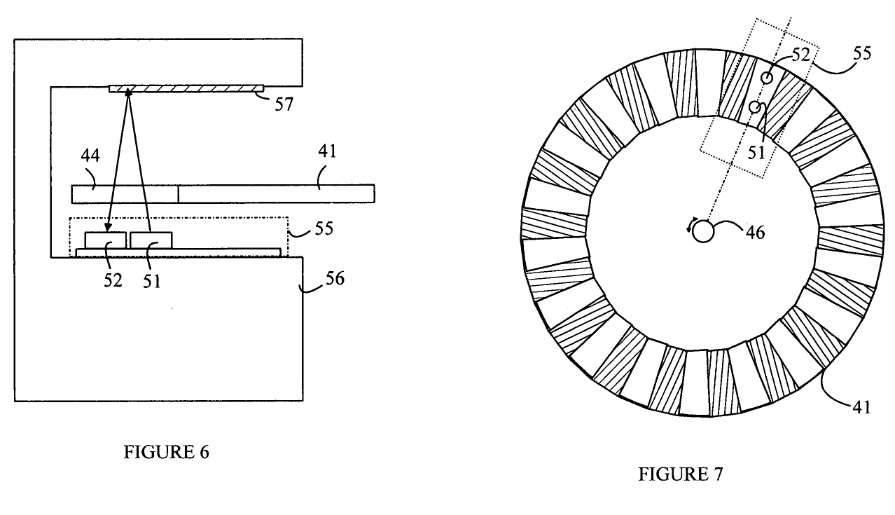

Refer now to FIGS. 4 and 5, which illustrate a rotational encoder 40 according to one embodiment of the present invention. FIG. 4 is a top view showing the code disk 41 and the underlying emitter-detector module 55. FIG. 5 is a cross-sectional view through 20 line 5-5 shown in FIG. 4.

Code disk 41 has an area at the middle and a series of clear and opaque bands in a region 44 along its outer edge. An exemplary transparent band is shown at 42, and an exemplary opaque band is shown at 43. Code disk 41 rotates about shaft 46. The present invention includes an encoder having a carrier that passes through an opening in a mounting body. The carrier includes an encoding region having a plurality of clear and opaque regions, the carrier having first and second surfaces. The clear and opaque regions of the carrier pass through the opening in the mounting body when the carrier moves relative to the mounting body. A light emitter generates a light signal that passes through the carrier, the light emitter being located adjacent to the first side of the carrier and separated therefrom. A light reflector is attached to the mounting body at a position such that the light reflector directs the light signal through the second surface of the carrier. A photodetector measures light leaving the first surface of the carrier when one of the clear regions passes through the light signal as the carrier moves relative to the mounting body. The photodetector is located on the same side of the carrier as the light emitter. The light emitter and photodetector can be attached to the mounting body. The light reflector can include one or more mirrors positioned such that collimated light generated by the light emitter passes through the code strip at right angles. The central region of code strip 41 between shaft 46 and the plurality of opaque bands is also transparent in this embodiment. In the view shown in FIG. 4, the code disk is positioned such that one of the transparent regions overlies the emitter-detector module 55.

Refer now to FIG. 5. Code disk 41 is suspended such that the bands pass through a gap 48 in a mounting body 56. Emitter-detector module 55 is located below code disk 41 within this gap. Emitter-detector module 55 includes a light emitter 51 and a photodetector 52. Light emitter 51 preferably includes a light source such as an LED and a collimating lens. Photodetector 52 can be constructed from one or more photodiodes and, optionally, a lens to adjust the magnification of the code disk image on the photodiodes. To simplify the drawing, the various lenses have been omitted in light emitter 51 and photodetector 52.

The upper surface of gap 48 includes a mirror 57. Mirror 57 reflects the collimated light 58 generated by light emitter 51 back down through the band region of code disk 41. Mirror 57, in effect, creates a virtual image of a collimated light source above code disk 41. Hence, encoder 40 behaves substantially the same as a conventional transmissive encoder while allowing the light emitter and photodetector to be packaged in a single emitter-detector module 55 that is mounted on mounting body 56. It should be noted that the distance between code disk 41 and emitter-detector module 55 is not critical, since the various lens that have critical spacings with respect to the light emitter and photodetector are packaged in emitter-detector module 55.

The angle of incidence of the collimated light on code disk 41 is preferably 90 degrees to better simulate a collimated source directly above photodetector 52. The arrangement shown in FIG. 5 can only approximate such an arrangement. However, by moving the emitter 51 closer to photodetector 52 as shown in FIG. 6, this condition can be substantially satisfied. FIG. 7 illustrates an embodiment of an encoder according to the present invention in which light emitter 51 is placed as close to photodetector 52 as possible. It should be noted that light emitter 51 can be placed below the region 44 of code disk 41 that includes the opaque and clear bands if light emitter 51 is aligned with photodetector 52 such that each clear band allows the light from light emitter 51 to reach mirror 57 when photodetector 52 is also under the clear band. Such an arrangement is shown in FIG. 7, which is a top view of code disk 41 with the light emitter and photodetector positioned in a radial manner under the code disk.

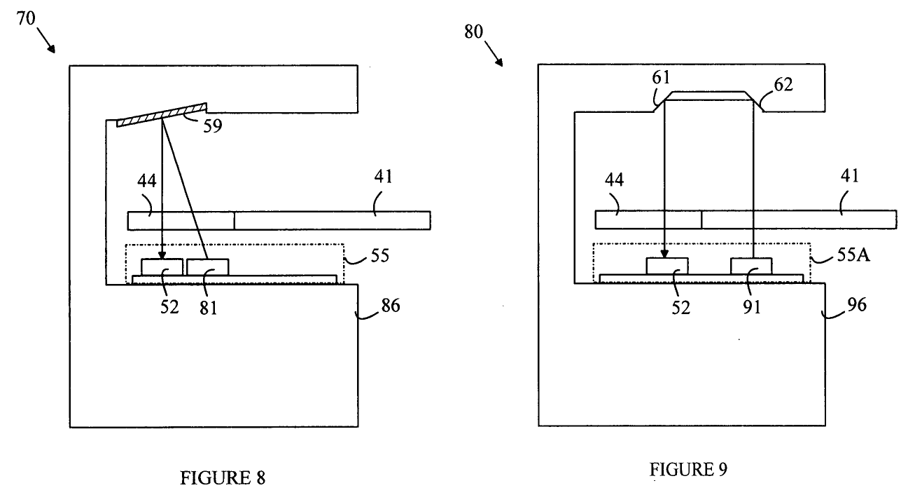

Refer now to FIG. 8, which is a cross-sectional view of another embodiment of an encoder according to the present invention. Encoder 70 provides the desired normal incidence of the collimated light on code disk 41 by replacing mirror 57 with a mirror 59 that is angled with respect to the plane of code disk 41 such that the light leaving mirror 59 strikes code disk 41 at 90 degrees. In this embodiment, the mounting body 86 is similar to mounting body 56 discussed above except for the portion used to mount mirror 59.

While the arrangement shown in FIG. 8 solves the problem of providing normal incidence for the collimated light, the arrangement complicates the optics in light emitter 81. To provide a collimated beam that leaves the light emitter at the correct angle, either the plane lens in light emitter 81 must be tipped or the collimating lens must be off center. Such an arrangement places constraints on the fabrication of emitter-detector module 55.

Refer now to FIG. 9, which is a cross-sectional view of another embodiment of an encoder according to the present invention. Encoder 80 provides the desired normal incidence of the collimated light on the code strip while utilizing a more conventional optical arrangement in which the collimated light leaves light emitter 91 at an angle that is normal to the surface of the LED and code disk 41. Encoder 80 utilizes two mirrors shown at 61 and 62 in a mounting body 96 to redirect the collimated light from light emitter 91 in emitter-detector module 55A back through code disk 41 at right angles to the plane of code disk 41 and photodetector 52. Since mirrors 61 and 62 reflect the collimated light, the distance between the mirrors is not critical, and hence, light emitter 91 can be placed under the clear interior region of code disk 41.

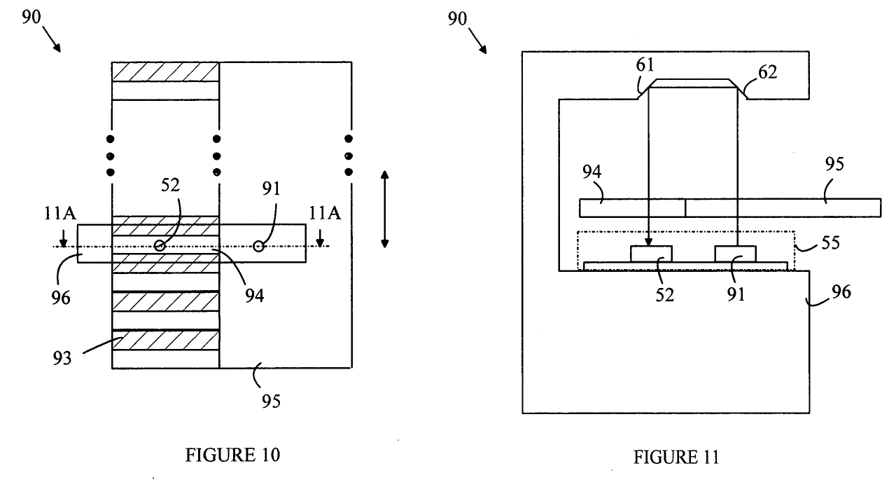

The above-described embodiments of the present invention have been directed to shaft encoders in which the angle of rotation of a shaft such as shaft 46 shown in FIG. 4 is measured. However, embodiments of the present invention directed to providing a measurement of a linear displacement can also be constructed using an analogous mounting body and an emitter-detector module. Refer now to FIGS. 10 and 11, which illustrate one embodiment of a linear encoder according to the present invention. FIG. 10 is a top view of a linear encoder 90 that measures the displacement of a linear code strip 95 with respect to a mounting body 96 having a light emitter 91 and light detector 52 arranged in an emitter-detector module similar to that discussed above with reference to FIG. 9. FIG. 11 is a cross-sectional view through line 11A-11A shown in FIG. 10. The code strip includes a series of clear and opaque bands in a region 94 along one edge of the code strip. An exemplary opaque band is shown at 93. It should be noted that the same emitter-detector module and mounting body used in the embodiments shown in FIGS. 6 and 8 could also be utilized in encoder 90.

In the above-described embodiments of the present invention, the encoding pattern carrier includes a top and bottom surface and the emitter-detector module is placed under the code strip while the reflector is positioned above the top surface. However, these designations are arbitrary. Embodiments of the present invention in which the emitter-detector module is placed above the carrier and the reflector below the code strip can also be constructed in a manner analogous to that described above.

The light emitters used in the above embodiments of the present invention are typically an LED with a collimating lens. However, it will be appreciated that other forms of light emitter can be utilized. For example, semiconductor lasers provide collimated light signals without the need for a collimating lens.

Similarly, the photodetectors discussed in the above embodiments are typically constructed from photodiodes. However, it will be appreciated that other forms of photodetector can be utilized provided the photodetector provides an electrical signal that measures the amount of light received by the photodetector. For example, semiconductor-based photodetectors based on phototransistors can be utilized.

The above-described embodiments of the present invention utilize a single photodetector for measuring the light passing through the encoding pattern carrier. However, embodiments of the present invention that utilize multiple photodetectors positioned such that the resulting signals provide a measure of the direction of travel of the carrier and/or interpolate the distance traveled to an accuracy greater than that of a single band on the carrier can also be utilized in place of the single photodetector described above. Such detector arrangements are known to the art, and hence, will not be described in detail here. For the purposes of the present discussion, it is sufficient to note that such detectors operate by forming an image of the code pattern on the surface of a detector array having a plurality of adjacent photodetectors whose areas correspond to the bands in the encoding pattern image that is projected onto the individual photodetectors.

Various modifications to the present invention will become apparent to those skilled in the art from the foregoing description and accompanying drawings. Accordingly, the present invention is to be limited solely by the scope of the following claims.

What is claimed is:

1. An encoder comprising:
a carrier comprising an encoding region having a plurality of clear and opaque regions, said carrier having first and second surfaces;
a mounting body having an opening through which said clear and opaque regions of said carrier pass, said carrier moving relative to said mounting body such that said clear and opaque regions pass through said opening;
a light emitter that generates a light signal that passes through said carrier, said light emitter being located adjacent to said first side of said carrier and separated therefrom;
a light reflector attached to said mounting body at a position, said light reflector directing said light signal through said second surface of said carrier; and
a photodetector that measures light leaving said first surface of said carrier when one of said clear regions passes through said light signal as said carrier moves relative to said mounting body.

2. The encoder of claim 1 wherein said light emitter and said photodetector are attached to said mounting body.

3. The encoder of claim 1 wherein said light reflector comprises a first mirror positioned such that light leaving said mirror passes through said carrier at right angles to said second surface.

4. The encoder of claim 3 wherein said light signal comprises collimated light that strikes said first surface of said carrier at right angles to said first surface of said carrier and wherein said light reflector comprises a second mirror for reflecting said light signal into said first mirror.

5. The encoder of claim 1 wherein said light emitter is positioned such that said light signal passes through one of said clear regions of said carrier when said light signal leaving that clear region is measured by said photodetector.

6. The encoder of claim 1 wherein said carrier further comprises a clear region separate from said encoding region and wherein said light signal leaving said light emitter passes through that clear region.
